(19) United States
(12) Patent Application Publication
(10) Pub. No.: US 2016/0078894 A1
(43) Pub. Date: Mar. 17, 2016

(54) BASE MEMBER, SPINDLE MOTOR HAVING THE SAME, AND RECORDING DISK DRIVING DEVICE

(71) Applicant: SAMSUNG ELECTRO-MECHANICS CO., LTD., Suwon-Si (KR)

(72) Inventor: Jae Woon PARK, Suwon-Si (KR)

(73) Assignee: SAMSUNG ELECTRO-MECHANICS CO., LTD., Suwon-Si (KR)

(21) Appl. No.: 14/679,774

(22) Filed: Apr. 6, 2015

(30) Foreign Application Priority Data
Sep. 11, 2014 (KR) 10-2014-0120461

(51) Int. Cl. G11B 19/20; H02K 3/38

(52) U.S. Cl. CPC G11B 19/2009; H02K 3/38

(57) ABSTRACT

There is provided a spindle motor including: a stator core around which a coil is wound; a base member to which the stator core is fixedly attached and in which a coil lead hole is disposed below the stator core; and a coating layer which is provided in the coil lead hole and in the vicinity of the coil lead hole.

### CROSS-REFERENCE TO RELATED APPLICATION

This application claims the priority and benefit of Korean Patent Application No. 10-2014-0120461 filed on Sep. 11, 2014, with the Korean Intellectual Property Office, the disclosure of which is incorporated herein by reference.

### BACKGROUND

The present disclosure relates to a base member, a spindle motor having the same, and a recording disk driving device.

In a hard disk drive (HDD), an information storage device, a read/write head (hereinafter, referred to as a head) writes data to a disk or reads data stored on a disk.

In addition, a motor for rotating the disk is used in the hard disk drive as described above. The motor, a device converting electrical energy into mechanical energy using force applied to a conductor in which current flows within a magnetic field, basically generates driving force rotating the disk through electromagnetic interaction between a magnet and a coil.

Further, in order to generate the driving force rotating the disk, the coil needs to be electrically connected to the outside, such that the current is supplied from the outside thereto. To this end, one end portion of the coil needs to penetrate through a base and be led out from an internal space of a housing including the base and a cover to the outside to thereby be bonded to and installed on a circuit board.

However, since the hard disk drive is not normally driven when the coil and the base are shorted, an insulation sheet or insulation bush is commonly installed on the base in order to prevent short-circuits of the coil and the base.

Therefore, a manufacturing yield may be deteriorated, manufacturing costs may be increased, and rigidity of the base may be increased due to an increase in a lead hole through which the coil penetrates in order to attach the insulation sheet and install the insulation bush.

### RELATED ART DOCUMENT

(Patent Document 1) Japanese Patent Laid-Open Publication No. 2011-114892

### SUMMARY

An aspect of the present disclosure may provide a base member having improved rigidity.

According to an aspect of the present disclosure, a spindle motor may include: a stator core around which a coil is wound; a base member to which the stator core is fixedly attached and in which a coil lead hole disposed below the stator core is formed; and a coating layer provided in the coil lead hole and in the vicinity of the coil lead hole.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic cross-sectional view showing a spindle motor including a base member according to an exemplary embodiment of the present disclosure;

FIG. 2 is an enlarged view of part A of FIG. 1;

FIG. 3 is a cut-away perspective view showing a portion of the base member according to an exemplary embodiment of the present disclosure;

FIG. 4 is a schematic cross-sectional view showing a spindle motor according to another exemplary embodiment of the present disclosure; and

FIG. 5 is a schematic cross-sectional view showing a recording disk driving device according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

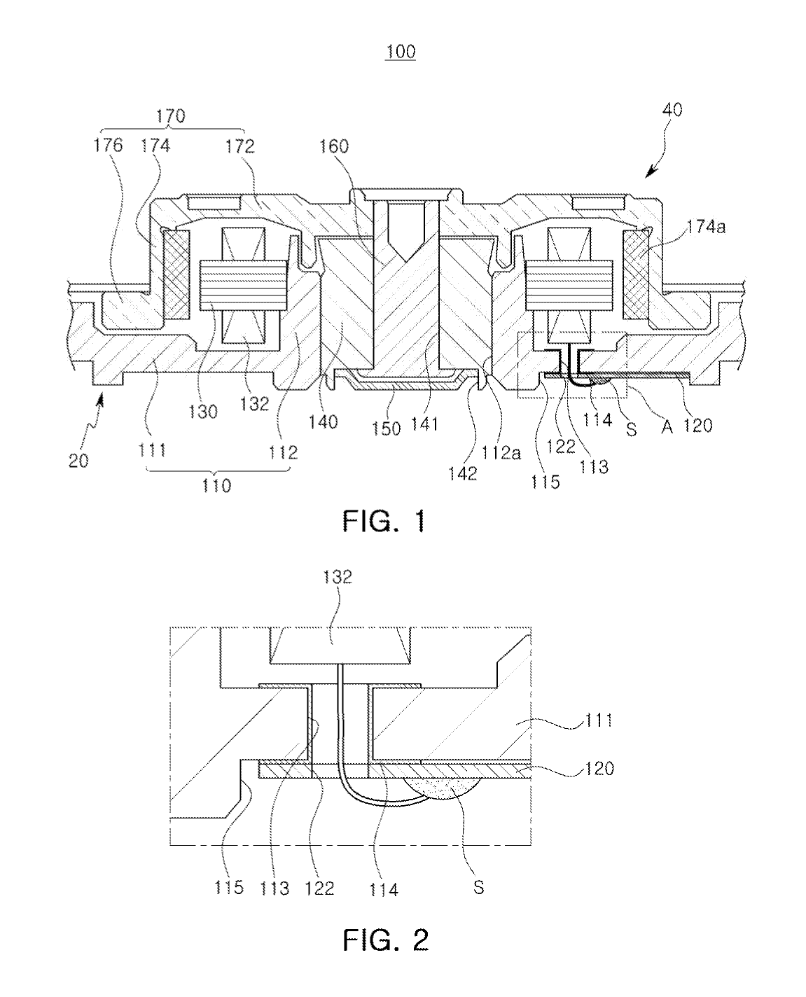

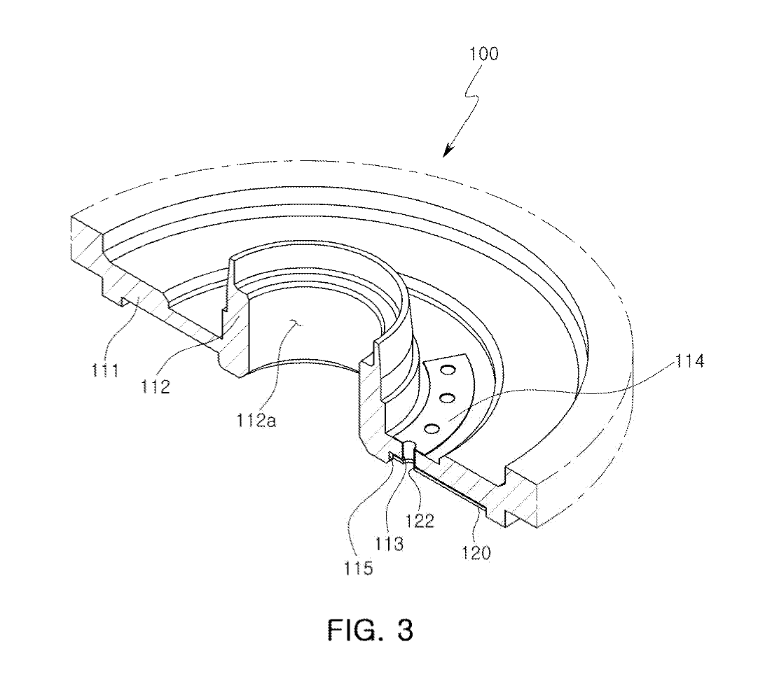

FIG. 1 is a schematic cross-sectional view showing a spindle motor including a base member according to an exemplary embodiment of the present disclosure, FIG. 2 is an enlarged view of part A of FIG. 1, and FIG. 3 is a cut-away perspective view showing a portion of the base member according to an exemplary embodiment of the present disclosure.

Referring to FIGS. 1 through 3, a spindle motor 100 according to an exemplary embodiment of the present disclosure may include a base member 110, a circuit board 120, a stator core 130, a sleeve 140, a cover member 150, a shaft 160, and a rotor hub 170 by way of example.

Meanwhile, the spindle motor 100 according to an exemplary e embodiment of the present disclosure may be a motor used, for example, in a recording and reproducing device such as a recording disk driving device, or the like.

In addition, the spindle motor 100 according to an exemplary embodiment of the present disclosure may be mainly configured of a stator part 20 and a rotor part 40.

The stator part 20, which means all fixed members except for rotating members, may include the base member 110, the circuit board 120, the stator core 130, the sleeve 140, and the cover member 150.

In addition, the rotor part 40, which means a rotating member, may include the shaft 160 and the rotor hub 170.

Here, terms with respect to directions will be defined. As viewed in FIG. 1, an axial direction refers to a vertical direction, that is, a direction from a lower end portion of the shaft 160 toward an upper end portion thereof or a direction from the upper end portion of the shaft 160 toward the lower end portion thereof, and a radial direction refers to a horizontal direction, that is, a direction from the shaft 160 toward an outer peripheral surface of the rotor hub 170 or a direction from the outer peripheral surface of the rotor hub 170 toward the shaft 160.

In addition, a circumferential direction refers to a rotation direction along an outer peripheral surface of the shaft 160.

The base member 110 may include a body part 111, an installation part 112 protruding from the body part 111 in the axial direction, at least one coil lead hole 113 disposed in the vicinity of the installation part 112, and a coating layer 114 for insulation provided in the coil lead hole 113 and in the vicinity of the coil lead hole 113.

A lower end portion of the sleeve 140 may be bonded and installed to an inner peripheral surface of the installation part 112. That is, an installation hole 112a may be formed in the installation part 112, and the lower end portion of the sleeve 140 may be insertedly disposed in the installation hole 112a. Further, the stator core 130 may be fixedly installed to an outer peripheral surface of the installation part 112.

Meanwhile, the coil lead hole 113 may be formed in the body part 111 so as to be disposed under the stator core 130, and as an example, four coil lead holes 113 may be formed so that a lead portion of a coil 132 wound around the stator core 130 penetrates through the coil lead holes 113.

Further, an installation groove 115 depressed from a bottom surface of the body part 111 may be formed in the base member 110. The circuit board 120 may be insertedly disposed in the installation groove 115 so as to be connected to the coil lead hole 113.

The coating layer 114 may serve to prevent a short-circuit from being generated by a contact between the lead portion of the coil 132 and the base member 110. To this end, the coating layer 114 may be formed of a synthetic resin material.

Further, the coating layer 114 may be formed on upper and lower surfaces of the body part 111 and an inner surface of the coil lead hole 113.

As described above, since the coating layer 114 is formed in the base member 110, there is no need to install a configuration such as an insulation sheet, an insulation bush, or the like, in the base member 110. Therefore, a manufacturing yield may be improved, and a manufacturing cost may be decreased.

In addition, since the insulation bush may not be installed, and generation of the short-circuit between the base member 110 and the lead portion of the coil 132 may be prevented, a size of the coil lead hole 113 may be decreased, such that rigidity of the base member 110 may be improved.

Therefore, impact resistance and vibration resistance characteristics may be improved.

Meanwhile, the base member 110 may be manufactured by die-casting using an aluminum material.

The circuit board 120 may be insertedly disposed in the installation groove 115 formed in the bottom surface of the base member 110 to thereby be connected to the lead portion of the coil 132. In addition, a through hole 122 connected to the coil lead hole 113 may be formed in the circuit board 120, and the lead portion of the coil 132 may pass through the coil lead hole 113 and the through hole 122 to thereby be bonded to the circuit board 120 by a solder part S.

In addition, the solder part S may be disposed in the installation groove 115 in order to prevent an increase in a thickness.

Meanwhile, the circuit board 120 may be a flexible circuit board.

The stator core 130 may be fixedly installed to the installation part 112 of the base member 110 as described above to thereby be disposed over the coil lead hole 113. Meanwhile, the coil 132 may be wound around the stator core 130, and the lead portion of the coil 132 may pass through the coil lead hole 113 and the through hole 122 to thereby be electrically connected to the circuit board 120.

The sleeve 140 may be fixedly installed to the installation part 112 of the base member 110. That is, the lower end portion of the sleeve 140 may be inserted into the installation part 112, and the sleeve 140 may be installed to the installation part 112 by at least one of a press-fitting method, a welding method, and an adhesion method.

Further, the sleeve 140 may include a shaft hole 141 formed therein so that the lower end portion of the shaft 160 may be insertedly disposed thereinto. That is, the lower end of the shaft 160 may be insertedly disposed in the shaft hole 141. Further, an inner peripheral surface of the sleeve 140 and an outer peripheral surface of the shaft 160 may be disposed so as to be spaced apart from each other by a predetermined interval, thereby forming a bearing clearance filled with a lubricating fluid.

Meanwhile, an installation groove 142 for installing the cover member 150 may be formed in the lower end portion of the sleeve 140.

In addition, the sleeve 140 may have upper and lower radial dynamic pressure grooves (not shown) formed in an inner surface thereof in order to generate fluid dynamic pressure by pumping the lubricating fluid filled in the bearing clearance. The shaft 160 may be more stably rotated by dynamic pressure formed by the upper and lower radial dynamic pressure grooves as described above.

The cover member 150 may be bonded and installed to the installation groove 142 of the sleeve 140. In addition, the cover member 150 may have a disk shape and serve to prevent the lubricating fluid from being leaded from the bearing clearance.

Meanwhile, the cover member 150 may also be bonded and installed to the installation groove 142 by at least one of an adhesion method and a welding method.

The shaft 160 may be insertedly disposed in the shaft hole of the sleeve 140 and supported by fluid dynamic pressure generated at the time of rotation. In addition, the upper end portion of the shaft 160 may protrude upwardly of the sleeve 140 in order to install the rotor hub 170.

In addition, the rotor hub 170 is fixedly installed to the upper end portion of the shaft 160 to thereby rotate together with the shaft 160. The rotor hub 170 may include a body 172 having a disk shape, a magnet mounting part 174 extended downwardly from an edge of the body 172 in the axial direction, and a disk supporting part 176 extended from the magnet mounting part 174 in the radial direction.

In addition, a driving magnet 174a may be fixedly installed to an inner surface of the magnet mounting part 174. Therefore, an inner surface of the driving magnet 174a may be disposed to face a front end of a stator core 130.

Meanwhile, the driving magnet 174a may be a permanent magnet generating magnetic force having a predetermined strength by alternately magnetizing an N pole and an S pole thereof in the circumferential direction.

Here, a rotational driving scheme of the rotor part 40 will be simply described. When power is applied to the coil 132 wound around the stator core 130, driving force rotating the rotor hub 170 may be generated by electromagnetic interaction between the stator core 130 including the coil 132 wound therearound and the driving magnet 174a, thereby rotating the rotor hub 170.

That is, the rotor hub 170 may be rotated by the electromagnetic interaction between the driving magnet 174a and the stator core 130 including the coil 132 wound therearound and disposed to face the driving magnet 174a.

In addition, the shaft 160 to which the rotor hub 170 is installed may be rotated together with the rotor hub 170 by rotation of the rotor hub 170.

As described above, since the insulation sheet or insulation bush may not be installed in the base member 110 due to the coating layer 114, the manufacturing yield may be improved, and at the same time, the manufacturing cost may be decreased.

In addition, since the insulation bush may not be installed, the size of the coil lead hole 113, for example, a diameter may be decreased, such that rigidity of the base member 110 may be improved.

Therefore, impact resistance and vibration resistance characteristics may be improved.

Hereinafter, a spindle motor according to another embodiment of the present disclosure will be described with reference to the accompanying drawings.

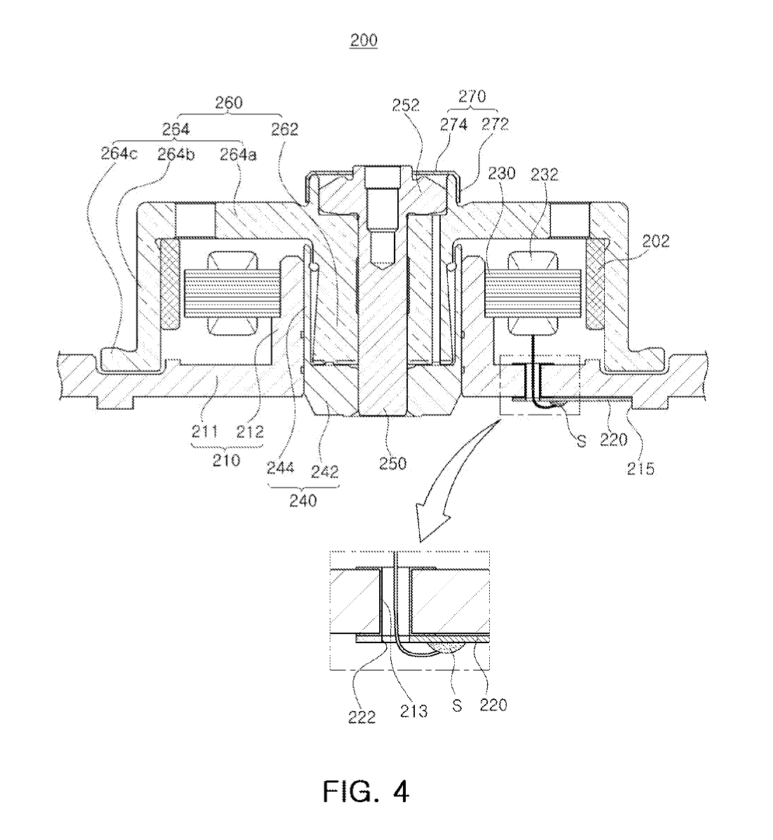

FIG. 4 is a schematic cross-sectional view showing a spindle motor according to another exemplary embodiment of the present disclosure.

Referring to FIG. 4, a spindle motor 200 according to another exemplary embodiment of the present disclosure may include, for example, a base member 210, a circuit board 220, a stator core 230, a lower thrust member 240, a shaft 250, a rotating member 260, and a cap member 270.

The base member 210 may include a body part 211, an installation part 212 protruding from the body part 211 in the axial direction, at least one coil lead hole 213 disposed in the vicinity of the installation part 212, and a coating layer 214 for insulation provided in the coil lead hole 213 and in the vicinity of the coil lead hole 213.

The lower thrust member 240 may be bonded and installed to an inner peripheral surface of the installation part 212. That is, an installation hole 212a may be formed in the installation part 212, and the lower thrust member 240 may be insertedly disposed in the installation hole 212a. Further, the stator core 230 may be fixedly installed to an outer peripheral surface of the installation part 212.

Meanwhile, the coil lead hole 213 may be formed in the body part 211 so as to be disposed under the stator core 230, and as an example, four coil lead holes 213 may be formed so that a lead portion of a coil 232 wound around the stator core 230 penetrates through the coil lead holes 213.

Further, an installation groove 215 depressed from a bottom surface of the body part 211 may be formed in the base member 210. The circuit board 220 may be insertedly disposed in the installation groove 215 so as to be connected to the coil lead hole 213.

The coating layer 214 may serve to prevent a short-circuit from being generated by a contact between the lead portion of the coil 232 and the base member 210. To this end, the coating layer 214 may be formed of a synthetic resin material.

Further, the coating layer 214 may be formed on upper and lower surfaces of the body part 211 and an inner surface of the coil lead hole 213.

As described above, since the coating layer 214 is formed in the base member 210, there is no need to install a configuration such as an insulation sheet, an insulation bush, or the like, in the base member 210. Therefore, a manufacturing yield may be improved, and a manufacturing cost may be decreased.

In addition, since the insulation bush may not be installed, and generation of the short-circuit between the base member 210 and the lead portion of the coil 232 may be prevented, a size of the coil lead hole 213 may be decreased, such that rigidity of the base member 210 may be improved.

Therefore, impact resistance and vibration resistance characteristics may be improved.

Meanwhile, the base member 210 may be manufactured by die-casting using an aluminum material.

The circuit board 220 may be insertedly disposed in the installation groove 215 formed in the bottom surface of the base member 210 to thereby be connected to the lead portion of the coil 232. In addition, a through hole 222 connected to the coil lead hole 213 may be formed in the circuit board 220, and the lead portion of the coil 232 may pass through the coil lead hole 213 and the through hole 222 to thereby be bonded to the circuit board 220 by a solder part S.

In addition, the solder part S may be disposed in the installation groove 215 in order to prevent an increase in a thickness.

Meanwhile, the circuit board 220 may be a flexible circuit board.

The stator core 230 may be fixedly installed to the installation part 212 of the base member 210 as described above to thereby be disposed over the coil lead hole 213. Meanwhile, the coil 232 may be wound around the stator core 230, and the lead portion of the coil 232 may pass through the coil lead hole 213 and the through hole 222 to thereby be electrically connected to the circuit board 220.

The lower thrust member 240 may be inserted into the installation hole 212a of the installation part 212, and an outer peripheral surface of the lower thrust member 240 may be bonded to an inner peripheral surface of the installation part 212.

In this case, the lower thrust member 240 may be fixedly installed to the installation part 212 by at least one of an adhesion method, a press-fitting method, and a welding method.

Meanwhile, the lower thrust member 240 may have a disk shape and include a disk part 242 in which a mounting hole 242a is formed so that a lower end portion of the shaft 250 is inserted thereinto and a sealing wall part 244 extended upwardly from an edge of the disk part 242 in the axial direction.

In addition, the lower thrust member 240 may form a bearing clearance filled with a lubricating fluid together with the rotating member 260. Further, the sealing wall part 244 may form an interface between the lubricating fluid and air (that is, a liquid-vapor interface) together with the rotating member 260.

The lower end portion of the shaft 250 may be fixedly installed to the lower thrust member 250, and an upper end portion thereof may be provided with a flange part 252.

As an example, the lower end portion of the shaft 250 may be inserted into the mounting hole 242a of the lower thrust member 240 to thereby be fixedly installed to the lower thrust member 240. That is, the spindle motor 200 according to another exemplary embodiment of the present disclosure may have a shaft-fixed structure in which the shaft 250 is fixedly installed.

Meanwhile, the shaft 250 may form the bearing clearance in which the lubricating fluid is filled, together with the rotating member 260. Further, the flange part 252 of the shaft 250 may form a sealing part in which the liquid vapor interface is formed together with the rotating member 260.

The rotating member 260 may rotate based on the shaft 250. Meanwhile, the rotating member 260 may include a sleeve 262 forming the bearing clearance together with the lower thrust member 240 and the shaft 250, and a rotor hub 264 extended from the sleeve 262.

The sleeve 262 may be disposed between the flange part 252 of the shaft 250 and the disk part 242 of the lower thrust member 240 and form the bearing clearance together with the shaft 250 and the lower thrust member 240. Meanwhile, a shaft hole 262a through which the shaft 250 penetrates may be formed in the sleeve 262.

In addition, upper and lower radial dynamic pressure grooves (not shown) may be formed in at least one of an inner peripheral surface of the sleeve 262 or the outer peripheral surface of the shaft 250. The upper and lower radial dynamic pressure grooves may be disposed to be spaced apart from each other in the axial direction by a predetermined interval, and generate fluid dynamic pressure in the radial direction at the time of rotation of the sleeve 262. Therefore, the rotating member 260 may more stably rotate.

The rotor hub 264 may be extended from the sleeve 262. Meanwhile, although the case in which the rotor hub 264 and the sleeve 262 are formed integrally with each other is described in the present exemplary embodiment by way of example, the present disclosure is not limited thereto. The rotor hub 264 and the sleeve 262 may be separately manufactured and assembled with each other.

Meanwhile, the rotor hub 264 may include a body 262a having a disk shape, a magnet mounting part 264b extended downwardly from an edge of the body 262a in the axial direction, and a disk support part 264c extended from a distal end of the magnet mounting part 264b in the radial direction.

In addition, a driving magnet 202 may be fixedly installed to an inner surface of the magnet mounting part 264b. Therefore, an inner surface of the driving magnet 202 may be disposed to face a front end of the stator core 230.

Meanwhile, the driving magnet 202 may be a permanent magnet generating magnetic force having a predetermined strength by alternately magnetizing an N pole and an S pole thereof in a circumferential direction.

The cap member 270 may be fixedly installed to the rotating member 260 and serve to prevent leakage of the lubricating fluid. Meanwhile, the cap member 270 may include a bonding part 272 of which an inner peripheral surface is bonded and installed to the rotating member 260 and a cover part 274 bent inwardly from the bonding part 272 in an inner diameter direction.

That is, in the case in which the bonding part 272 of the cap member 270 is bonded to the rotating member 260, the cover part 274 may be disposed on the flange part 252 of the shaft 250 to prevent leakage of the lubricating fluid.

As described above, since the insulation sheet or insulation bush may not be installed in the base member 210 due to the coating layer 214, the manufacturing yield may be improved, and at the same time, the manufacturing cost may be decreased.

In addition, since the insulation bush may not be installed, a size of the coil lead hole 213, for example, a diameter may be decreased, such that rigidity of the base member 210 may be improved.

Therefore, impact resistance and vibration resistance characteristics may be improved.

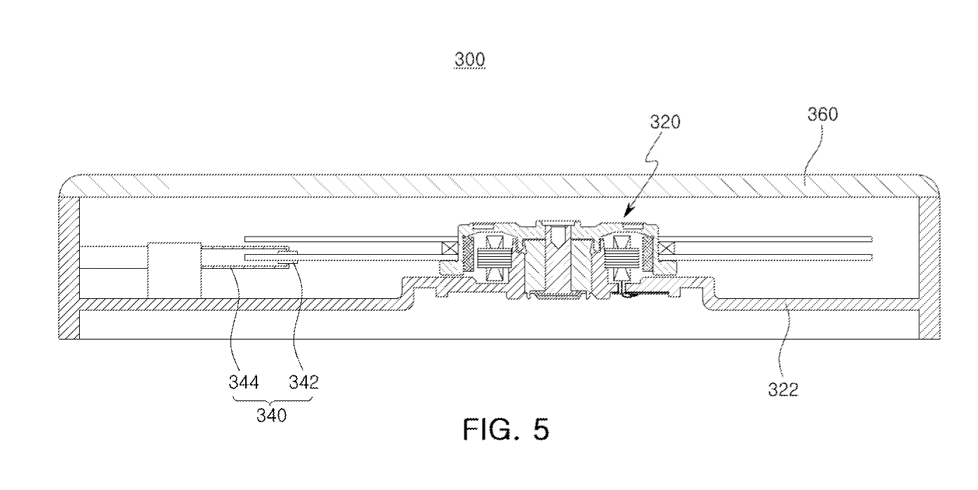

FIG. 5 is a schematic cross-sectional view showing a recording disk driving device according to another exemplary embodiment of the present disclosure.

Referring to FIG. 5, a recording disk driving device 300 according to another exemplary embodiment of the present disclosure may include, for example, a spindle motor 320, ahead transfer part 340, and an upper case 360.

The spindle motor 320 may be any one of the above-mentioned spindle motors 100 and 200 according to an exemplary embodiment and another exemplary embodiment of the present disclosure, and a recording disk D may be mounted on the spindle motor 320.

The head transfer part 340 may transfer a head 342 detecting information of the recording disk D mounted on the spindle motor 320 to a surface of the recording disk D of which the information is to be detected. The head 342 may be disposed on a support part 344 of the head transfer part 340.

The upper case 360 may be coupled to a base member 322 in order to form an internal space for accommodating the spindle motor 320 and the head transfer part 340.

As set forth above, according to exemplary embodiments of the present disclosure, rigidity may be improved, and impact resistance and vibration resistance characteristics may be improved.

While exemplary embodiments have been shown and described above, it will be apparent to those skilled in the art that modifications and variations could be made without departing from the scope of the present invention as defined by the appended claims.

What is claimed is:

1. A base member comprising:
a body part;
an installation part protruding from the body part in an axial direction;
at least one coil lead hole disposed in the vicinity of the installation part; and
a coating layer for insulation provided in the coil lead hole and in the vicinity of the coil lead hole.

2. The base member of claim 1, wherein the coating layer is provided on upper and lower surfaces of the body part and an inner surface of the coil lead hole.

3. The base member of claim 2, wherein the coating layer is formed of a synthetic resin material for insulation.

4. A spindle motor comprising:
a stator core around which a coil is wound;
a base member to which the stator core is fixedly attached and in which a coil lead hole is disposed below the stator core; and
a coating layer which is provided in the coil lead hole and in the vicinity of the coil lead hole.

5. The spindle motor of claim 4, wherein the base member includes:
a body part;
an installation part which is extended from the body part in an axial direction and on which the stator core is installed; and
the core lead hole which is disposed in the vicinity of the installation part.

6. The spindle motor of claim 5, wherein the coating layer is provided on upper and lower surfaces of the body part and an inner surface of the coil lead hole.

7. The spindle motor of claim 6, wherein the coating layer is formed of a synthetic resin material for insulation.

8. The spindle motor of claim 4, further comprising a circuit board inserted into an installation groove provided in a bottom surface of the base member to thereby be connected to a lead portion of the coil.

9. The spindle motor of claim 8, wherein the circuit board has a through hole through which the lead portion of the coil penetrates, and
a solder part for connection of the lead portion of the coil is disposed in the installation groove.

10. A recording disk driving device comprising:
the spindle motor of claim 4, rotating a recording disk;
a head transfer part transferring a head reading information from and writing information to the recording disk mounted on the spindle motor to the recording disk; and
an upper case coupled to the base member provided in the spindle motor so as to form an internal space for accommodating the spindle motor and the head transfer part.
